(19) United States
(12) Patent Application Publication
(10) Pub. No.: US 2019/0336890 A1
(43) Pub. Date: Nov. 7, 2019

(54) Snap-On Porous Filter Media For Filter Press Plates

(71) Applicant: FLSmidth A/S, Valby (DK)

(72) Inventor: Brent STOKES, The Woodlands, TX (US)

(21) Appl. No.: 16/345,999

(22) PCT Filed: Oct. 27, 2017
(86) PCT No.: PCT/IB2017/056690

§ 371 Date: Apr. 29, 2019

Related U.S. Application Data
(60) Provisional application No. 62/414,938, filed on Oct. 31, 2016.

(51) Int. Cl. B01D 25/176; B01D 39/16; B01D 25/00; B29D 99/00

(52) U.S. Cl. CPC B01D 25/176; B01D 39/1661; B01D 25/001; B01D 2239/1275; B01D 2239/065; B01D 2239/1208; B29D 99/005

(57) ABSTRACT

Filter media (100) for dewatering slurry is disclosed. The filter media (100) may comprise a filtering body (105) comprising non-occluded porous material (105a) and occluded porous material (105b). At least one upper tab (101) comprising at least one upper locking element (102) and at least one lower tab (104) comprising at least one lower locking element (103) may be provided to the filter media (100) as means for attaching the filter media (100) to a filter plate (300). The filter plate (300) may comprise at least one upper locking element (302) provided to an upper end surface (301) of the filter plate (300) and at least one lower locking element (303) provided to a lower end surface (304) of the filter plate (300); wherein the at least one upper tab (101) of the filter media (100) is configured to communicate with the at least one upper locking element (302) of the filter plate (300) and wherein the at least one lower tab (104) of the filter media (100) is configured to communicate with the at least one lower locking element (303) at the lower end surface (304) of the filter plate (300). A method of manufacturing the filter media is also described.

### FIELD OF THE INVENTION

The current invention relates to filter media, primarily for use in large scale industrial dewatering processes, and methods of manufacturing and installing the same. In particular, disclosed is filter media comprised of porous material, such as a sheet which is made up of sintered particles. The filter media is specially adapted to be joined to a vertically-oriented filter plate of an industrial filter press (e.g., a center feed filter press, a corner feed filter press, a recessed chamber/recessed plate filter press, a horizontal filter press, a sidebar filter press, an automatic or semi-automatic filter press, etc.) and may be easily affixed to and easily removed from a filter plate. Filter plates may be easily modified to accept such filter media as a retrofit solution.

### BACKGROUND OF THE INVENTION

Filter cloths for filter presses are normally comprised of felt formed from polypropylene. The polypropylene is heated, and then melt blown (hot blown while molten) onto a moving bed. During melt blowing, the molten polypropylene is extruded into open air and cooled on the moving bed, and needled, to create a needled felt product which is capable of filtering.

Melt blown polypropylene is difficult to clean when used as a filtering medium. Another problem with old-fashioned needled felt used in filter media, is that it tends to deform against filter plate profiles and geometries. This can negatively affect filtration performance, create wear spots/open holes, or concentrate non-filtrate material in certain portions of the filter media. In particular, portions of the filter media that lie adjacent to filtrate ports, feed eye, “pip(s)”, or other feature(s) commonly associated with a filter plate for use with an industrial filter press, may be prone to wear or material buildup. Drawbacks of conventional supported needle felt also include rapid dirtying, and low structural stability.

There is a need to provide a wear/abrasion-resistant, chemically-tolerant, low-stick, easily installable, and easily-removable filter media which can be readily fabricated economically. There is a further need to provide filter media which can be customized to particular industrial processes, tailored to specific slurry types or slurry compositions, slurry particle sizes, slurry particle roughness, slurry dewatering properties, slurry moisture content, and the like; for example, in order to provide an efficiency rating to filter media that can be tailored to a particular process.

Reference is made to the following publications: DE 10 2004 063408 A, DE 299 23857 U, and WO 99/12634.

### OBJECTS OF THE INVENTION

According to some embodiments, an object of the present invention is to provide filtration media having a porous body with measurable porosity that can be predetermined, rather than traditional needled felt which can only be measured by air permeability, fiber size, and weight.

According to some embodiments, an object of the present invention is to provide filter media, which can easily be attached to and removed from filter plates.

According to some embodiments, an object of the present invention is to provide filter media, which can be easily and/or cheaply manufactured.

According to some embodiments, an object of the present invention is to provide filter media, which demonstrates longevity in harsh industrial filtration environments.

According to some embodiments, an object of the present invention is to provide filter media, which has an improved ability to stay clean.

According to some embodiments, an object of the present invention is to provide filter media having a low potential for pore occlusion by solids (e.g., slurry particles/filtered particles).

According to some embodiments, an object of the present invention is to provide filter media, which possesses low-stick or non-stick characteristic properties.

According to some embodiments, an object of the present invention is to provide filter media which can be given an efficiency rating, based on the type of industrial filtration process and the physical characteristic properties of particles in the slurry to be filtered (e.g., particle roughness, abrasiveness, hardness, density, composition/material, mean size).

According to some embodiments, an object of the present invention is to make a filter media, which can be customized during manufacturing to more appropriately filter a unique slurry based on the type of industrial filtration process and the physical characteristic properties of particles in the slurry, (e.g., roughness, abrasiveness, hardness, density, composition/material, mean size), including viscosity or Reynold's number of the slurry.

According to some embodiments, an object of the present invention is to provide filter media having an ability to seal and/or dampen during filtration operations.

According to some embodiments, an object of the present invention is to provide filter media having an ability to discourage or prevent lateral migration of solids (e.g., slurry particles/filtered particles) within the filter media.

These and other objects of the present invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

Disclosed, is filter media 100 for dewatering slurry in an industrial filter press (not shown). The industrial filter press may comprise a wide stack of vertically oriented, horizontally-stacked filter plates 300, which are horizontally movable with respect to each other, in order to open an close gaps therebetween, without limitation. In preferred embodiments, the industrial filter press comprises a horizontal filter press (e.g., an FLSmidth® Shriver® filter press), which may be set up as an automatic/automated filter plate press (e.g., an FLSmidth® Eimco® AFP IV filter press), without limitation. Filter plates 300 may comprise recessed chambers.

Embodiments of the filter media 100 comprise a filtering body 105. The filtering body 105 comprises a non-occluded porous material 105a. A portion of the non-occluded porous material 105a may be occluded (e.g., with a polymeric material). In this regard, the filtering body 105 may comprise both occluded porous material 105b, and non-occluded porous material 105a. The filtering body 105 may comprise at least one opening 105c, 105d in order to allow a gas (e.g. ,air), liquid (e.g., filtrate), or slurry to pass therethrough. The at least one opening 105c extends entirely through the occluded porous material portion 105b of the filtering body 105 (for example, in the form of a filtrate hole, air blow hole, or slurry fill hole). The at least one opening may extend entirely through the non-occluded porous material portion 105a (for example, to form a feed eye hole for slurry to pass). Occluded porous material 105b optionally, but preferably, surrounds the at least one opening 105c, 105d. For example, occluded porous material may surround a filtrate hole, an air blow hole, a slurry feed hole, or a feed eye hole, without limitation.

At least one upper tab 101 may extend from the filtering body 105. The at least one upper tab 101 may comprise at least one upper locking element 102. The at least one upper tab 101 may extend from the filtering body 105 to form an upper edge 101a between the at least one upper tab 101 and the filtering body 105.

At least one lower tab 104 may extend from the filtering body 105. The at least one lower tab 104 may comprise at least one lower locking element 103. The at least one lower tab 104 may extend from the filtering body 105 to form a lower edge 104a between the at least one lower tab 104 and the filtering body 105.

The occluded porous material 105b may comprise a portion of the non-occluded porous material 105a that has been treated with a polymeric material to fill pores 105a″ therein. The polymeric material used for pore occlusion may be configured to discourage lateral migration of solids within the filtering body 105. The polymeric material used for occlusion may be configured to improve sealing around the filtering body 105. The polymeric material used for occlusion may be configured to discourage lateral migration of solids within the filtering body 105 and also improve sealing around the filtering body 105.

The filtering body 105 may be configured to cover a first 309 and/or a second 310 face of a filter plate 300. For example, as shown in FIG. 4, the filtering body 105 of a first filter media 100 may cover a first face 309 of a filter plate 300 and a filtering body 105 of another filter media 100 may cover a second face 310 of a filter plate 300. Also, for example, as shown in FIG. 9, a filter media 100 may cover both first 309 and second 310 faces of a filter plate 300 by wrapping over an upper end surface 301 of a filter plate 300 (i.e., adjacent an upper tab 101 of the filter media 100 comprising at least one upper locking element 102, the upper tab 101 being located proximate a middle fold location of the filter media 100).

A filter plate 300 configured for use with the filter media 100 described herein may comprise at least one upper locking element 302 provided to an upper end surface 301 of the filter plate 300, which is sufficiently configured to mate with, and retain by friction, at least one upper locking element 102 of the respective filter media 100. Preferably, the at least one upper locking element 302 is configured to retain all of the upper locking elements 102 provided to filter media 100. The filter plate 300 may further comprise at least one lower locking element 303 provided to a lower end surface 304 of the filter plate 300, which is sufficiently configured to mate with, and retain by friction, at least one lower locking element 103 of the respective filter media 100. Preferably, the at least one lower locking element 303 is configured to retain all of the lower locking elements 103 provided to filter media 100. A number of these filter plates 300 may be provided to an industrial filter press (not shown), or provided to a user, with or without filter media 100. Filter media 100 may also be pre-installed on a number of these filter plates 300 (e.g., prior to sale, during shipment, or on a “ready rack”) or installed on filter plates 300 in-situ; for example, after the filter plates 300 have been installed within the industrial filter press.

In complementary fashion, the at least one upper locking element 102 of the at least one upper tab 101 of the filter media 100 is configured to communicate with the at least one upper locking element 302 at the upper end surface 301 of the filter plate 300, so as to prevent removal of the filtering body 105 from the filter plate 300 during use. Moreover, the at least one lower locking element 103 of the at least one lower tab 104 of the filter media 100 is configured to, in complementary fashion, communicate with the at least one lower locking element 303 at the lower end surface 304 of the filter plate 300, so as to prevent removal of the filtering body 105 from the filter plate 300 during use.

In some embodiments, the non-occluded porous material 105a may comprise fabric, a woven material, or a needled felt material. However, in most-preferred embodiments, the non-occluded porous material 105a comprises a sintered porous material. The sintered porous material may be comprised of metallic or polymeric particles. In most-preferred embodiments, the sintered porous material is comprised of a plurality of polymeric sintered particles 105a′, pores 105a″ between the sintered particles 105a′, and a number of fenestrations 105a″′ which may extend between the sintered particles 105a′. At least some of the sintered particles 105a′ may be comprised of a polymer selected from the group consisting of: polyethylene, high-density polyethylene (HDPE), ultra-high molecular weight polyethylene (UHMWPE), polypropylene, polyester, polycarbonate, polyvinylidene fluoride, polytetrafluoroethylene, polyvinylidene fluoride, ethyl vinyl acetate, polycarbonate, polycarbonate alloy, nylon 6, thermoplastic polyurethane (TPU), polyethersulfone (PES), and polyethylene-polypropylene copolymer. It should be understood that more than one of these aforementioned polymers may be present in any combination. For example, a sintered particle 105a′ may comprise a polymeric blend comprising a combination of two or more of the aforementioned polymers. As another example, a sintered particle 105a′ may be formed by sintering a composite or homogeneous polymeric particle that has been coated with another type of polymer. Sintered particles 105a′ may comprise similar materials throughout the non-occluded porous material 105a, or the non-occluded porous material 105a may comprise a number of sintered particles 105a″ each comprising different types of polymers, polymer blends, polymeric compositions, or polymeric composites, without limitation. In some embodiments, some of the sintered particles 105a′ within the porous material 105a may be formed by sintering single polymer particles; and others 105a′ within the porous material 105a may be formed by sintering polymer-coated polymeric particles, without limitation.

In some embodiments, at least some of the sintered particles 105a′ are comprised of a thermoplastic elastomer selected from the group consisting of: thermoplastic polyurethanes, polyisobutylene, polybutenes, polyethylene-propylene copolymer, polyethylene-butane copolymer, polyethylene-octene copolymer, polyethylene-hexene copolymer, chlorinated polyethylene, chloro-sulfonated polyethylene, styrene-ethylene-butadiene-styrene, multiblock copolymers having a polyurethane and either a polyester or polyether, and 1,3-dienes, without limitation.

In some embodiments, the non-occluded porous material 105a of the filter media 100 may comprise a reticulated structure having a mean porosity between 10% and 90%, for example, between 20% and 80%, without limitation. In some embodiments, the non-occluded porous material 105a may comprise a rigidity, according to ASTM D747, of less than 15 pounds.

The at least one upper locking element 102 of the at least one upper tab 101 may comprise a first upper tab edge 101b, a first upper locking element face 102a, and a first upper locking element edge 102b. The first upper tab edge 101b is preferably configured to communicate with a first upper end surface edge 301b provided to an upper end surface 301 of a filter plate 300 (e.g., which is adjacent an upper end surface 301 of a filter plate 300 and forms a portion of the at least one upper locking element 302). The first upper locking element face 102a is also preferably configured to communicate with a first upper locking element face 302a (e.g., which is adjacent an upper end surface 301 of a filter plate 300 and forms a portion of at least one upper locking element 302). The first upper locking element edge 102b may be configured to communicate with the first upper locking element face 302a, or a first upper locking element edge 302b adjacent an upper end surface 301 of a filter plate 300 and forming a portion of the at least one upper locking element 302. The first upper locking element face 102a preferably forms an undercut with an upper end surface 301 of a filter plate 300.

The at least one lower locking element 103 of the at least one lower tab 104 may comprise a first lower tab edge 104b, a first lower locking element face 103a, and a first lower locking element edge 103b. The first lower tab edge 104b is preferably configured to communicate with a first lower end surface edge 304b provided to a lower end surface 304 of a filter plate 300 (e.g., which is adjacent a lower end surface 304 of a filter plate 300 and forms a portion of the at least one lower locking element 303). The first lower locking element face 103a is preferably configured to communicate with a first lower locking element face 303a (e.g., which is adjacent a lower end surface 304 of a filter plate 300 and forms a portion of the at least one lower locking element 303). The first lower locking element edge 103b may be configured to communicate with the first lower locking element face 303a, or a first lower locking element edge 303b adjacent a lower end surface 301 of a filter plate 300 and forming a portion of the at least one lower locking element 303. In preferred embodiments, the first lower locking element face 303a forms an undercut with a lower end surface 304 of a filter plate 300.

The at least one upper locking element 102 of the at least one upper tab 101 may comprise a second upper locking element face 102c extending from the first upper locking element edge 102b to a second upper locking element edge 102d. The at least one upper locking element 102 of the at least one upper tab 101 may further comprise a third upper locking element face 102e extending from the second upper locking element edge 102d to a second upper tab edge 101c. The second upper tab edge 101c of the filter media 100 may be configured to communicate with a third upper locking element face 302e or a second upper end surface edge 301c provided to the upper end surface 301 of a filter plate 300. The second upper locking element face 102c of the filter media 100 may be configured to communicate with a second upper locking element face 302c (e.g., which is adjacent the upper end surface 301 of a filter plate 300 and forms a portion of the at least one upper locking element 302). The second upper locking element edge 102d of the filter media 100 may be configured to communicate with a second upper locking element edge 302d adjacent the upper end surface 301 of a filter plate 300 and forming a portion of the at least one upper locking element 302. The third upper locking element face 102e of the filter media 100 preferably forms an undercut with the upper end surface 301 of a filter plate 300. The angle formed between the third upper locking element face 102e of the filter media 100 and the second upper locking element face 102c of the filter media 100 is preferably an acute angle.

A method of manufacturing embodiments of the filter media 100 described herein is also disclosed. According to some embodiments, the method may comprise the step of sintering polymeric particles 105a′ together to form a filtering body 105. The filtering body 105 may, for example, comprise non-occluded porous material 105a being defined by a number of pores 105a″ and fenestrations 105a′″. The method may further comprise a step of forming or providing at least one upper tab 101, which extends from the filtering body 105 for a tab depth 108. The method may further comprise a step of forming or providing at least one upper locking element 102 on the at least one upper tab 101. The method may further comprise a step of forming or providing at least one lower tab 104, which extends from the filtering body 105 for a tab depth 108. The method may further comprise a step of forming or providing at least one lower locking element 103 on the at least one lower tab 104. The method may further comprise a step of intentionally occluding a portion of the non-occluded porous material 105a of the filtering body 105 with a polymeric material to create a region of occluded porous material 105b, wherein the polymeric material used for occlusion of pores 105a″ may deter lateral migration or progression of solids through the occluded pores 105a″. The method may further comprise a step of forming or providing at least one opening 105c, 105d through the filtering body 105, for example, a central opening 105d for slurry to pass, and/or a corner opening 105c for air, slurry, or filtrate to pass. In some embodiments of the method described, the step of forming or providing at least one opening 105c, 105d through the filtering body 105 may comprise forming or providing a corner opening 105c through a portion of the occluded porous material 105b. In some embodiments of the method described, the step of forming or providing at least one opening 105c, 105d through the filtering body 105 may comprise forming or providing a central opening 105d through occluded porous material 105b or non-occluded porous material 105a of the filtering body 105.

In some embodiments, a flared rotary cutting tool, such as a cutter or bit capable to be used with a drill, router, mill, or rotary cutting tool may be used to form the at least one upper locking element 302 and/or the at least one lower locking element 303, without limitation. Alternatively, a flared disk may be provided to an angle grinder, biscuit joiner, plate joiner, or circular saw to form at least one upper 302 or lower 303 locking element comprising an undercut, dovetail, or partial dovetail. Alternatively, a series of angled mitre cuts may be made using a straight blade in an angle grinder, biscuit joiner, plate joiner, or circular saw to form at least one upper 302 or lower 303 locking element comprising an undercut, dovetail, or partial dovetail.

For example, a flared bit may be passed along the entire width 106b of an upper end surface 301 of a filter plate 300, and/or a flared bit may be passed along the entire width 106b of a lower end surface 304 of a filter plate 300, without limitation. Accordingly, methods disclosed herein may comprise the step of forming or providing at least one upper locking element (302) on an upper end surface (301) of a filter plate (300), the at least one upper locking element (302) comprising a first upper end surface edge (301b), a first upper locking element face (302a), a first upper locking element edge (302b), a second upper locking element face (302c), a second upper locking element edge (302d), a third upper locking element face (302e), and a second upper end surface edge (301c); wherein the first upper locking element face (302a) forms an undercut with the upper end surface (301); and wherein the second upper locking element face (302e) forms an undercut with the upper end surface (301). The step of forming or providing at least one upper locking element (302) on an upper end surface (301) of a filter plate (300) may be performed using a flared rotary cutting tool. The flared rotary cutting tool may be a bit capable of use within a drill, router, mill, or rotary cutting tool.

A filter plate 300 for an industrial filter press, which is specially configured to be used in conjunction with filter media 100 described herein, is further disclosed. The filter plate 300 may have an upper end surface 301 comprising at least one upper locking element 302. The at least one upper locking element may be defined, for example, by a first upper end surface edge 301 b, a first upper locking element face 302a, a first upper locking element edge 302b, and a second upper locking element face 302c, without limitation. The filter plate 300 may have a lower end surface 304 comprising at least one lower locking element 303. The at least one lower locking element 303 may be defined, for example, by a first lower end surface edge 304b, a first lower locking element face 303a, a first lower locking element edge 303b, and a second lower locking element face 303c, without limitation. The filter plate 300 may further comprise a first face 309, a second face 310, a first upper corner 301a adjacent the first face 309, a second upper corner 301a adjacent the second face 310, a first lower corner 304a adjacent the first face 309, and a second lower corner 304a adjacent the second face 310. The at least one upper locking element 302 of the filter plate 300 is preferably configured to receive the at least one upper locking element 102 of the filter media 100. Preferred embodiments of the at least one upper locking element 302 are configured to receive all upper locking elements 102 provided to the filter media 100. For example, if there are a plurality of upper locking elements 102 provided to the filter media 100, then the at least one upper locking element 302 may receive the plurality of upper locking elements 102 of the filter media 100. The at least one lower locking element 303 of the filter plate 300 is preferably configured to receive the at least one lower locking element 103 of the filter media 100. Preferred embodiments of the at least one lower locking element 303 are configured to receive all lower locking elements 103 provided to the filter media 100. For example, if there are a plurality of lower locking elements 103 provided to the filter media 100, then the at least one lower locking element 303 may receive the plurality of lower locking elements 103 of the filter media 100.

The filter plate 300 may comprise at least one opening 305c, 305d, and the at least one opening 305c, 305d may align with at least one opening 105c, 105d in filter media 100 being attached thereto. For example, an opening 105c, 105d extending entirely through a portion of occluded porous material 105b of the filtering body 105 of the filter media 100 may align with a respective opening 305c, 305d in the filter plate 300 as suggested in FIGS. 7 and 8, without limitation. According to some embodiments, a filter plate 300 may comprise a second upper locking element edge 302d, a third upper locking element face 302e, and a first upper end surface edge 301c. According to some embodiments, a filter plate 300 may comprise a second lower locking element edge 303d, a third lower locking element face 303e, and a second lower end surface edge 304c.

### BRIEF DESCRIPTION OF THE DRAWINGS

To complement the description which is being made, and for the purpose of aiding to better understand the features of the invention, a set of “not-to-scale” drawings is attached to the present specification as an integral part thereof, in which the following has been depicted with an illustrative and non-limiting character:

FIG. 1 is a partial side cutaway view of filter media according to some embodiments.

FIG. 2 is a front plan view of the filter media of FIG. 1, showing a first ace of the filtering body.

FIG. 3 is a partial side cutaway view of a filter plate according to some embodiments.

FIG. 4 represents a partial side view of the filter plate of FIG. 3 having installed thereon, two of the filter media shown in FIGS. 1 and 2.

FIG. 5 is a close up view of FIG. 4, showing how at least one upper locking element of a filter media may cooperate with at least one upper locking element of a filter plate according to some embodiments.

FIG. 6 is an enlarged fragmentary view of a sintered porous polymeric material used in the making of filter media, in particular, a filtering body, according to some embodiments.

FIG. 7 shows an embodiment where at least one upper locking element of a first filter media (shown) and at least one upper locking element of a second filter media (not shown) may both share at least one upper locking element provided to an upper end surface of a filter plate; and wherein at least one lower locking element of the first filter media and at least one lower locking element of the second filter media may both share at least one lower locking element provided to a lower end surface of the filter plate, without limitation.

FIG. 8 shows an embodiment where a first filter media (shown) may comprise at least one upper tab (e.g., a plurality of upper tabs), the at least one upper tab comprising at least one upper locking element, wherein a respective number of upper locking elements may be provided to an upper end surface of a filter plate to receive the at least one upper locking element of the filter media; and wherein the first filter media may comprise at least one lower tab (e.g., a plurality of lower tabs), the at least one lower tab comprising at least one lower locking element, wherein a respective number of lower locking elements may be provided to a lower end surface of a filter plate to receive the at least one lower locking element. An upper locking element may receive an upper locking element from both the first filter media (shown) and an upper locking element provided to a second filter media (not shown). A lower locking element of the filter plate may receive a lower locking element from both the first filter media (shown) and a lower locking element provided to a second filter media (not shown). The first filter media may be provided to a first side of the filter plate, and the second filter media may be provided to a second side of the filter plate. It should be understood that while only one locking element from each of the first and second filter media may be received by a respective locking element of the filter plate, a plurality of locking elements from each of the first and second filter media may be received by the same locking element provided to the filter plate.

FIG. 9 is a side cross-sectional view of a filter plate having filter media installed thereon. The figure shows an embodiment wherein instead of a first filter media being provided to a first side of a filter plate, and a separate second filter media being provided to a second side of a filter plate, a single filter media may be configured to cover both a first side and a second side of a filter plate, simultaneously; wherein the filter media may comprise a tab having at least one upper locking element (e.g., adjacent a middle fold location of the filter media where the filter media is intended to cover an upper end surface of a filter plate); and wherein the upper end surface of the filter plate comprises at least one upper locking element on its upper end surface which is complementary to the at least one upper locking element of the filter media. As shown, the ends of the filter media may each comprise at least one lower locking element (e.g., a barb comprising a first lower locking element face).

In the following, the invention will be described in more detail with reference to drawings in conjunction with exemplary embodiments.

### DETAILED DESCRIPTION OF THE INVENTION

The following description of the non-limiting embodiments shown in the drawings is merely exemplary in nature and is in no way intended to limit the inventions disclosed herein, their applications, or uses.

According to some embodiments, a filter media 100, in particular for dewatering slurry in an industrial filter press, may be comprised of a filtering body 105, at least one upper tab 101 extending from filtering body 105, and at least one lower tab 104 extending from filtering body 105. In some embodiments, an upper tab 101 may be substantially parallel to a lower tab 104 as shown in the drawings. In some embodiments, while not explicitly shown in the drawings, an upper tab 101 may extend at a converging/diverging angle with a lower tab 104, such that: a) the upper tab 101 and lower tab 104 are not parallel, or b) an angle formed between the upper tab 101 and the filtering body 105 is acute (or less than 90 degrees), or c) an angle between the lower tab 104 and the filtering body 105 is acute (or less than 90 degrees), without limitation.

In the particular embodiment shown, each of the upper 101 and lower 104 tabs extend approximately orthogonally (i.e., at approximately a right angle or 90 degrees) with respect to the filtering body 105, for a predetermined tab depth 108.

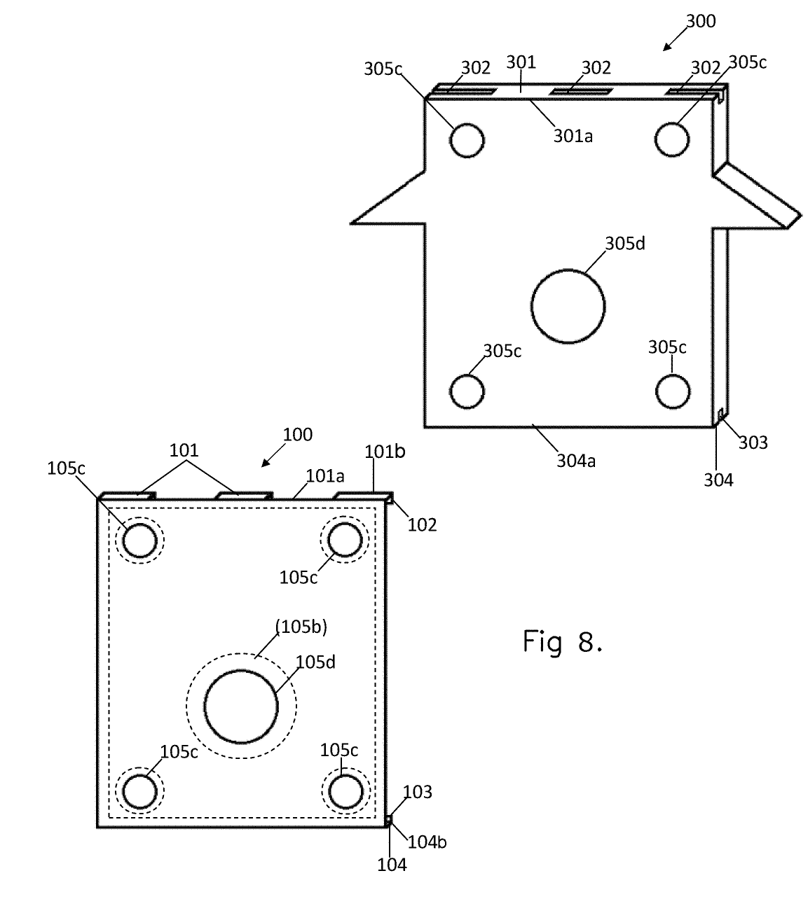

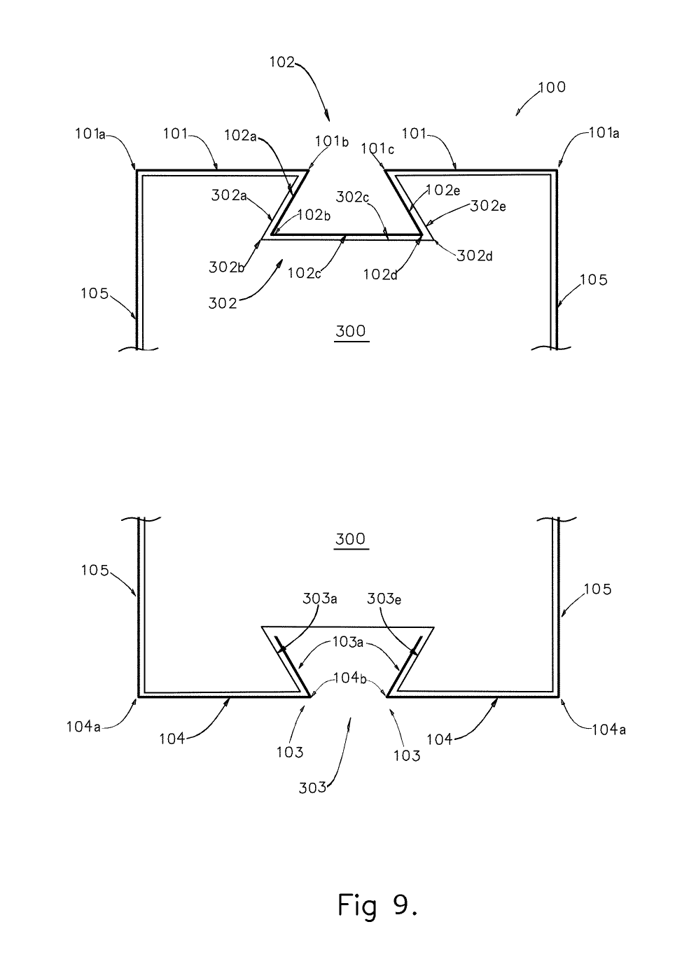

The depth 108 of each tab 101 104 may be similar or different, without limitation. For example, the depth 108 of an upper tab 101 may be greater than or less than a depth 108 of a lower tab 104, without limitation. If a plurality of upper tabs 101 are provided to a filter media 100 as suggested in FIG. 8, a depth 108 of each of the plurality of upper tabs 101 may be the same (as shown), or, upper tabs 101 may have different depths 108, without limitation. If a plurality of lower tabs 104 are employed to a filter media 100, a depth 108 of each of the plurality of lower tabs 101 may be the same, or lower tabs 104 may have different depths 108, without limitation.

The filtering body 105 may extend vertically for a distance 106a which is preferably commensurate with the approximate height of a filter plate 300. The filtering body 105 may extend laterally for a distance 106b which is preferably commensurate with the approximate width of a filter plate 300. The distance 106a representing the height of the filtering body 105 or height of a filter plate 300 is preferably much greater than tab depth(s) 108, and may be similar to a width 106b of the filtering body. In this regard, a filter media 100 is preferably configured so as to be form-fitting to a shape and/or size of a filter plate 300 to which it is attached. The distance 106a may not be exactly the same height as a filter plate 300, and therefore may be slightly less or slightly greater than a height of a filter plate 300, without limitation. The distance 106b may not be exactly the same width as a filter plate 300, and therefore may be slightly less or slightly greater than a width of a filter plate 300, without limitation. A thickness 107 of the filtering body 105, i.e., the distance between a first face 109 of the filtering body 105 and a second face 110 of the filtering body 105, may vary along the height 106a or width 106b of the filtering body 105. However, the thickness 107 of the filtering body 105 can also be substantially uniform as depicted in the drawings. It is contemplated that porosity and/or type of material may change across the thickness 107 of the filtering body 105, regardless of whether the thickness 107 is uniform or non-uniform. For example, a first layer of porous material 105a within the filtering body 105 having certain first porosity and/or certain first material characteristics may be physically joined with one or more second layers having certain second porosity and/or certain second material characteristics; wherein the first porosity characteristics may differ from the second porosity characteristics, and/or wherein the first material characteristics may differ from the first material characteristics, without limitation. The aforementioned may be accomplished, for example, by sintering two or more different sheets of porous material 105a together, followed by a masking and pore occlusion step to form a filtering body 105, without limitation.

In any of the embodiments shown or discussed herein, a tab 101, 104 may be constructed of or from a material provided to the filtering body 105 (e.g., an occluded 105b or non-occluded 105a porous material); or, a tab 101, 104 described herein may be constructed of a material which is dissimilar from a material provided to the filtering body 105 (e.g., a solid non-porous material, solid polymeric material, solid metallic material, or the like). In some non-limiting embodiments, the filtering body 105 may be formed separately from tabs 101, 104, using a first method (e.g., sintering particles to form porous material sheets which may be formed to size or cut down to size), and tabs 101, 104 may be formed using a second method (e.g., molding, extrusion, stamping, progressive forming) which is different than the first method. Means for attaching separately-formed tabs 101, 104 to the filtering body 105 may vary, and may include, without limitation, friction welding, heat welding, ultrasonic welding, adhesives, mechanical fasteners (e.g., rivets, plastic fasteners, etc.), clamping, stitching, combinations thereof, or the like.

Where described herein, tabs 101, 104 may, in any embodiment, be: a) integrally formed with filtering body 105 in a mold comprising a cavity in the final shape of the filter media 100; b) integrally formed with filtering body 105, in the same sheet, which is subsequently formed by bending to form the tabs 101, 104; or c) separately formed from the filtering body 105 and subsequently joined to the filtering body 105 via welding (ultrasonic, heat, friction), adhesive means, or mechanical fastening (e.g., plastic fasteners or bolting), without limitation. Filter media 100 may be formed by rapid prototyping (e.g. selective laser sintering or stereolithographic methods), or may be homogenously/monolithically formed from a single piece of porous material 105a which may be die cut and/or formed (e.g., via heat, progressive dies, stamping, press brakes, bending techniques, or other sheet fabrication techniques), without limitation. Filter media 100 may be formed from larger sheets of prefabricated porous material which may be produced in rolls or large sections of porous material, without limitation.

The junction between the upper tab 101 and filtering body 105 may form an upper corner 101a of the filter media 100. The upper tab 101 preferably comprises at least one upper locking element 102, such as a male fastener portion which can mate with a complementary female fastener portion provided to an upper end surface 301 of a filter plate 300 configured for use in an industrial filter press (not shown). Alternatively, while not shown, it is envisaged that a male fastener portion may be inversely provided to the upper end surface 301 of a filter plate 300, wherein the at least one upper locking element 102 may comprise a complementary female fastener portion which mates with said male fastener portion, without limitation.

In some embodiments the at least one upper locking element 102 of the filter media 100 may comprise a dovetail or a portion thereof, such as a barb. For example, at least one upper tab 101 may extend to a first upper tab edge 101b, which bends to a first upper locking element face 102a comprising a first upper locking element edge 102b (e.g., to form a barb or portion of a dovetail). In the shown embodiment, the at least one upper locking element 102 comprises a full dovetail locking mechanism, wherein a second upper locking element face 102c extends from the first upper locking element edge 102b to a second upper locking element edge 102d. Also as shown in the drawings, a third upper locking element face 102e may extend from the second upper locking element face 102c, at the second upper locking element edge 102d. The third upper locking element face 102e may eventually terminate at a second upper tab edge 101c. For example, as shown, the second upper tab edge 101c may be juxtaposed with the first upper tab edge 101b and positioned adjacent the second upper tab edge 101c. The first upper locking element face 102a and the third upper locking element face 102e are preferably converging/diverging, so as to form an undercut (e.g., trapezoidal in cross-section) projection extending downwardly from the upper tab 101. In the particular embodiment shown, the second upper locking element face 102c extends substantially parallel to the upper tab 101 although this may not be the case for every embodiment.

It will be readily appreciated by those skilled in the art that the exact termination point of the at least one upper locking element 102 may vary, depending on the amount of surface area necessary for friction to hold the filter media 100 to a filter plate 300, and that only the first upper locking element face 102a may be necessary in certain embodiments, depending on the intended purpose and/or application of the filter media 100.

The junction between the lower tab 104 and filtering body 105 may form a lower corner 104a of filter media 100. The lower tab 104 preferably comprises at least one lower locking element 103, such as a male fastener portion which can mate with a complementary female fastener portion provided to a lower end surface 304 of a filter plate 300 configured for use in an industrial filter press. Alternatively, while not shown, it is envisaged that a male fastener portion may be inversely provided to the lower end surface 304 of a filter plate 300, wherein the at least one lower locking element 103 may comprise a complementary female fastener portion which mates with said male fastener portion, without limitation.

In cases of the latter, those having an ordinary skill in the art would appreciate that geometries shown in the figures (in particular, geometries of the upper locking elements 102, 302 and/or lower locking elements 103, 303) could alternatively be inverted in some embodiments to the structural reciprocal of what is shown; wherein the upper locking element 102 of the filter media 100 may instead, extend upwards, rather than downwards as shown; wherein the upper locking element 302 of the filter plate 300 may instead, extend upwards, rather than downwards into the plate 300 as shown; or, wherein the lower locking element 103 of the filter media 100 may instead, extend downwards, rather than upwards as shown; wherein the lower locking element 303 of the filter plate 300 may instead, extend downwards, rather than upwards into the plate 300 as shown. in some embodiments, the at least one lower locking element 103 may comprise a full dovetail locking mechanism, similar to the upper locking element 102 shown in the drawings. However, in more preferred embodiments, such as shown, the lower locking element 103 comprises an abbreviated portion of a dovetail, such as a barb, as shown, in order to facilitate installation from above. It should be understood that the at least one upper locking element 102 provided to the at least one upper tab 101 may comprise a similar abbreviated portion of a dovetail, such as a barb, and may share a similar design as the at least one lower locking element 103. The lower tab 104 may extend to a first lower tab edge 104b, at which point a first lower locking element face 103a may protrude inward into the filter plate 300. The first lower locking element face 103a may extend to a first lower locking element edge 103b (e.g., in order to form a barb or portion of a dovetail). In the shown embodiment, the at least one lower locking element 103 comprises a partial dovetail locking mechanism (e.g., a barb), wherein no second or third lower locking element faces extend from the first lower locking element edge 103b as it does for the at least one upper locking element 102.

It will be readily appreciated by those skilled in the art that the exact termination point of the at least one lower locking element 103 may vary, depending on the amount of surface area necessary, for friction to hold the filter media 100 to a filter plate 300. Accordingly, it should be understood that more faces than what is shown for the first lower locking element face 103a may be necessary, depending on the intended purpose and/or application of the filter media 100.

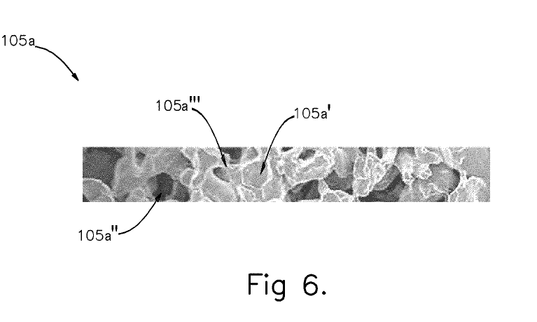

The filtering body 105 may be separate or monolithically integral with the upper 101 and/or lower 104 tabs. While it is envisaged that the filtering body 105 can comprise traditional filter media materials (e.g., needled felt, woven cloth, etc.), with upper and/or lower tabs 101, 104 being separately fabricated and ultrasonically welded, adhered, or mechanically fastened thereto, it is preferred that the filtering body 105 be constructed of a porous material, preferably a sintered porous material. The sintered porous material may be provided in the form of, for instance, a microporous sheet of sintered porous material as suggested in FIG. 6. The porous material 105a is preferably made from polymeric particles, although embodiments incorporating thin sheets of sintered metal particles are also contemplated.

As shown in the figures, in some embodiments, the filtering body 105 may comprise porous material 105a having non-occluded pores 105a″ defined by sintered particles 105a′ and fenestrations 105a′″ extending therebetween. A circumferential portion of the porous material 105a, or, a perimeter of the porous material 105a (i.e., defining an outer peripheral boundary of the filtering body 105) may be occluded with a polymeric material (e.g., a flexible, elastomeric, sealing material) to form a porous material having occluded pores 105b. For example, an elastomer may be applied to the porous material 105a to fill or substantially encapsulate pores 105a″ to form the occluded pore portion 105b. Other occlusion materials are envisaged, and may include, without limitation, silicone, caulk, or other water repellant product (e.g., a 3M ScotchGuard™ brand Heavy Duty Water Shield product, Flex Seal® Liquid Rubber product, etc.). The material selected for occluding pores 105a″ should be adequate enough to prevent ingress, egress, or lateral migration of slurry particles in the filtering body 105 (e.g., migration of slurry particles from central portions of the filtering body 105 to peripheral portions of the filtering body 105).

Preferably, the occluded porous material 105b is provided around the perimeter of the filtering body 105 and around one or more openings 105c, 105d that extend through the filtering body 105 of the filter media 100. Such openings 105c, 105d may include, for example, one or more corner openings 105c which are designed to let air, slurry, and/or filtrate to unobstructedly pass through the filtering body 105, Such openings 105c, 105d may also include, for example, one or more central openings 105d which are designed to let slurry unobstructedly pass through the filtering body 105 (e.g., through a feed eye region of a filter plate 300). Optionally, the pores 105a″ in an area surrounding the one or more central openings 105d may be occluded with a polymeric material (e.g., a flexible, elastomeric, sealing material) to form a porous material having occluded pores (105b). This optional occlusion zone is indicated by a dotted line region in FIG. 2 and denoted by “(105b)” with parentheses included.

Filter media 100, according to some embodiments, may be dropped between two parallel, vertically-oriented filter plates of an industrial filter press, securely affixed to the upper end surface 301 of a filter plate 300, and then snapped into a lower end surface 304 of the filter plate 300 to attach the filter media 100 to the filter plate 300. Removal of filter media 100 from a filter plate 300 may be commenced by popping out the upper 102 and/or lower 103 locking elements from their respective upper locking elements 302 and lower locking elements 303 provided to the filter plate 300. Alternatively, removal of filter media 100 from a filter plate 300 may be commenced by cutting (e.g., via a rotary cutting tool, razor, or other knife edge) portions of the upper 101 and/or lower 104 tabs, such as one or more portions of the at least one upper locking element 102 and/or one or more portions of the at least one lower locking element 103, without limitation.

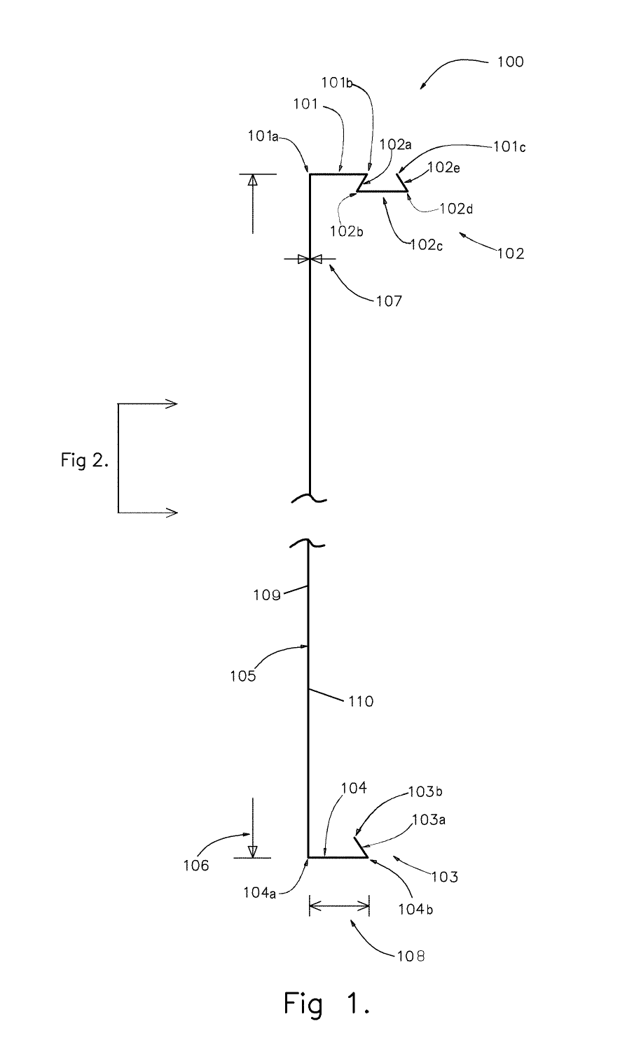

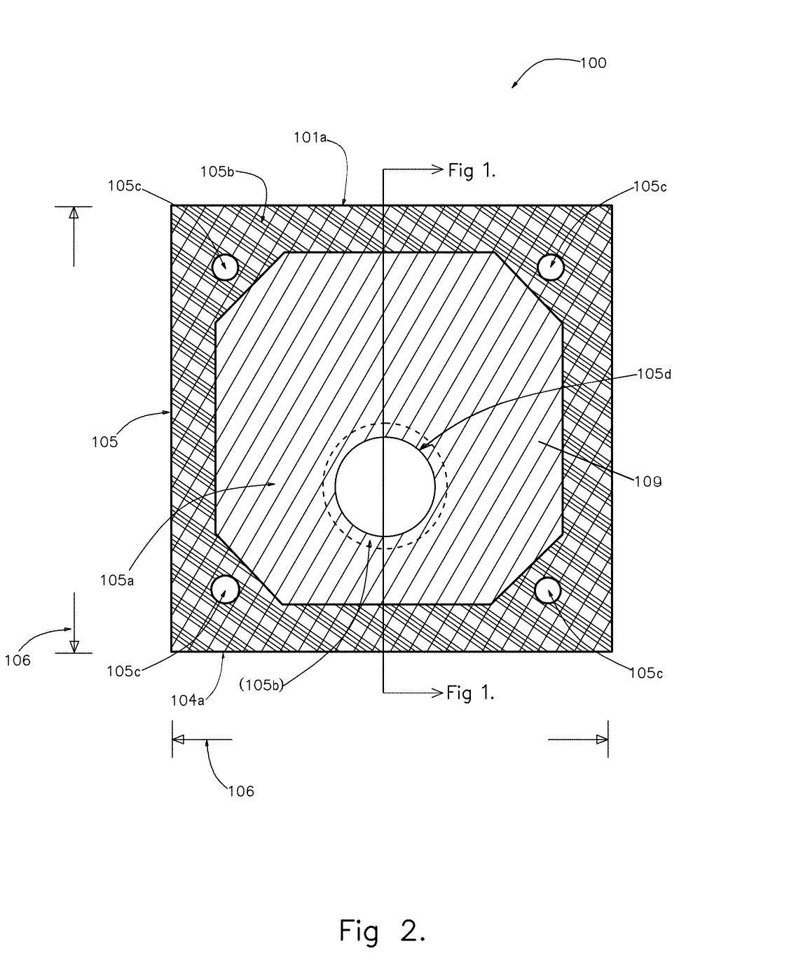

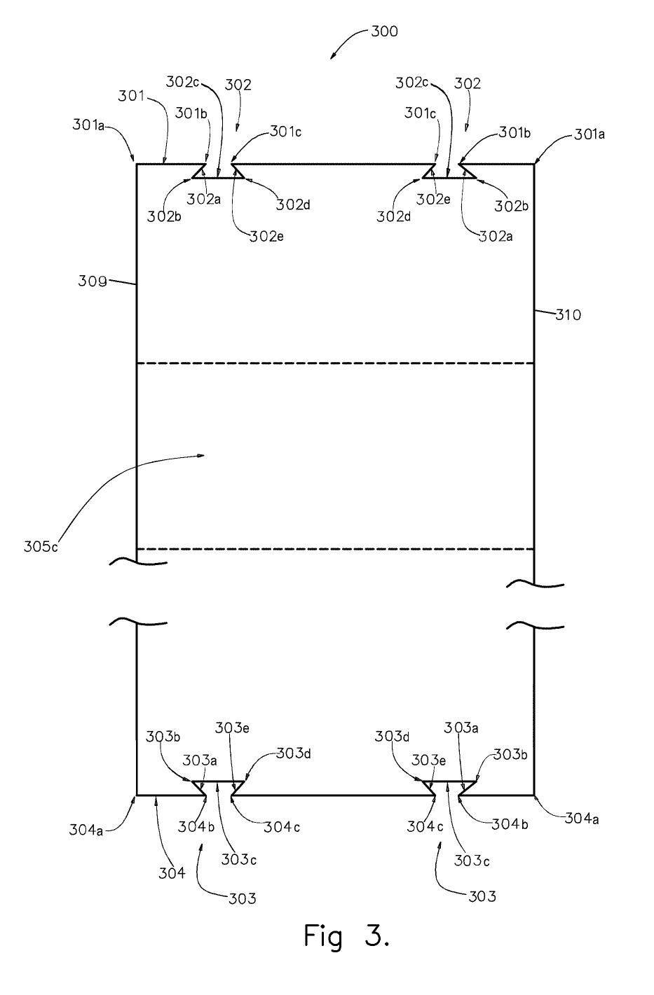

FIG. 3 shows a cross-sectional side profile partial cutaway view of a filter plate 300 for an industrial filter press according to some embodiments. As shown in FIGS. 3-5, a filter plate 300 may be adequately configured to receive a filter media 100 of the type described and exemplified in FIGS. 1-2. The filter plate 300 may comprise, for instance, an upper end surface 301, a lower end surface 304, a first face 309, and a second face 310. Along the upper end surface 301 and first face 309, an upper corner 301a is provided. Along the upper end surface 301 and the second face 310, another upper corner 301a is provided. Along the lower end surface 304 and first face 309, a lower corner 304a is provided. Along the lower end surface 304 and second face 310, another lower corner 304a is provided.

According to some embodiments, as shown in FIG. 3, an upper end surface 301 of the filter plate 300 may comprise at least one upper locking element 302 and at least one lower locking element 303, for example, two upper locking elements 302 and two lower locking elements 303, without limitation. Each upper locking element 302 is preferably adapted to correspondingly mate with at least one upper locking element 102 of filter media 100. Each lower locking element 303 is preferably adapted to correspondingly mate with at least one lower locking element 103 of filter media 100.

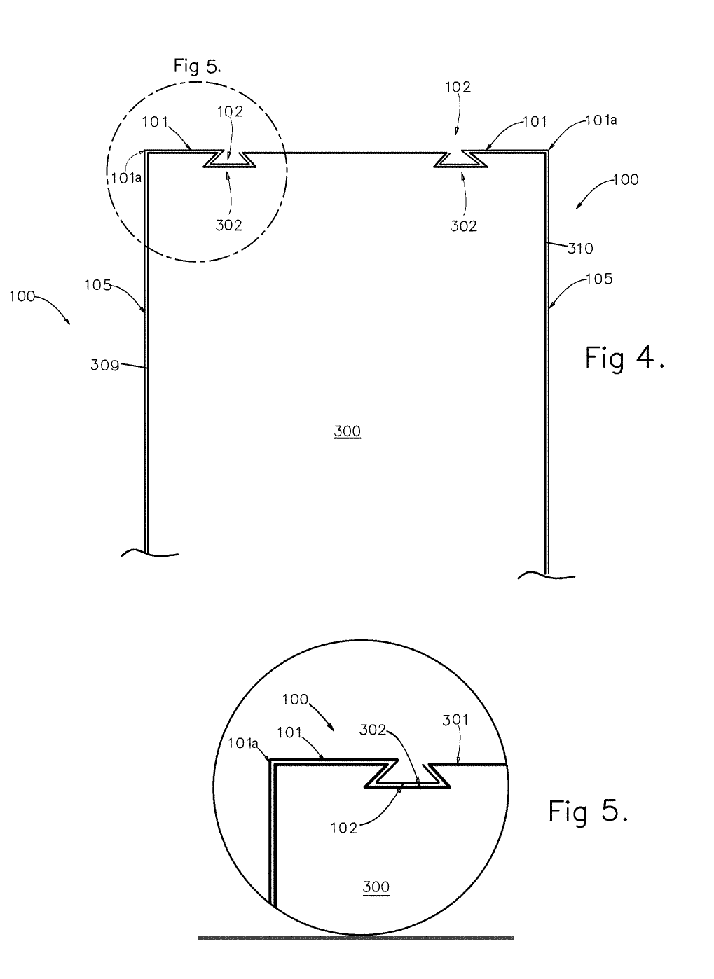

For example, the upper end surface 301 of the filter plate 300 may comprise at least one first side upper locking element 302 which is adapted to correspondingly mate with at least one upper locking element 102 of first filter media 100. The upper end surface 301 of the filter plate 300 may further comprise at least one second side upper locking element 302 which is adapted to correspondingly mate with at least one upper locking element 102 of second filter media 100. Moreover, a lower end surface 304 of the filter plate 300 may comprise at least one first side lower locking element 303, which is adapted to correspondingly mate with at least one lower locking element 104 of the first filter media 100. The lower end surface 304 of the filter plate 300 may further comprise at least one second side lower locking element 303 which is adapted to correspondingly mate with at least one lower locking element 104 of the second filter media 100. In this regard, as shown in FIGS. 4 and 5, two filter media 100 may be attached to a single filter plate 300, such that each of a first side 309 and second side 310 of the filter plate 300 may be covered with its own separate filtering body 105.

As depicted, each upper locking element 302 may comprise a first upper end surface edge 301b and a second upper end surface edge 301c; a first upper locking element face 302a extending from the first upper end surface edge 301b to a first upper locking element edge 302b, a second upper locking element face 302c extending from the first upper locking element edge 302b to a second upper locking element edge 302d, and a third upper locking element face 302e extending from the second upper locking element edge 302d to the second upper end surface edge 301c. The first upper locking element face 302a and the third upper locking element face 302e are preferably converging/diverging, so as to form an undercut extending downwardly from the upper end surface 301 of the filter plate 300 and into the filter plate 300.

As in the particular embodiment shown, the second upper locking element face 302c may extend substantially parallel to the upper end surface 301, without limitation. Similarly, each lower locking element 303 may comprise a first lower end surface edge 304b and a second lower end surface edge 304c;a first lower locking element face 303a extending from the first lower end surface edge 304b to a first lower locking element edge 303b, a second lower locking element face 303c extending from the first lower locking element edge 303b to a second lower locking element edge 303d, and a third lower locking element face 303e extending from the second lower locking element edge 303d to the second lower end surface edge 304c. The first lower locking element face 303a and the third lower locking element face 303e are preferably converging/diverging, so as to form an undercut extending upwardly from the lower end surface 304 of the filter plate 300 and into the filter plate 300. As in the particular embodiment shown, the second lower locking element face 303c may extend substantially parallel to the lower end surface 304, without limitation.

As the above applies to the first side 309 of the filter plate 300, it may also apply to the second side 310 of the filter plate 300. The at least one second side upper locking element 302 may comprise a first upper end surface edge 301b and a second upper end surface edge 301c; a first upper locking element face 302a extending from the first upper end surface edge 301b to a first upper locking element edge 302b, a second upper locking element face 302c extending from the first upper locking element edge 302b to a second upper locking element edge 302d, and a third upper locking element face 302e extending from the second upper locking element edge 302d to the second upper end surface edge 301c, The first upper locking element face 302a and the third upper locking element face 302e are preferably converging/diverging, so as to form an undercut extending downwardly from the upper end surface 301 of the filter plate 300 and into the filter plate 300. As in the particular embodiment shown, the second upper locking element face 302c may extend substantially parallel to the upper end surface 301, without limitation. Similarly, the at least one second side lower locking element 303 may comprise a first lower end surface edge 304b and a second lower end surface edge 304c; a first lower locking element face 303a extending from the first lower end surface edge 304b to a first lower locking element edge 303b, a second lower locking element face 303c extending from the first lower locking element edge 303b to a second lower locking element edge 303d, and a third lower locking element face 303e extending from the second lower locking element edge 303d to the second lower end surface edge 304c. The first lower locking element face 303a and the third lower locking element face 303e are preferably converging/diverging, so as to form an undercut extending upwardly from the lower end surface 304 of the filter plate 300 and into the filter plate 300. As in the particular embodiment shown, the second lower locking element face 303c may extend substantially parallel to the lower end surface 304, without limitation.

One or more corner openings 05c may be provided to the filter media 100. The one or more corner openings 105c are preferably configured to align with one or more corner openings 305c (e.g., filtrate hole(s), slurry fill hole(s), air blow hole(s)) provided to a filter plate 300. While not shown, one or more central openings 105d may be provided to the filter media 100. The one or more central openings 105d, if employed, are preferably configured to align with one or more central openings 305d extending through the filter plate 300, such as one or more slurry feed eye holes 305d provided to the filter plate 300.

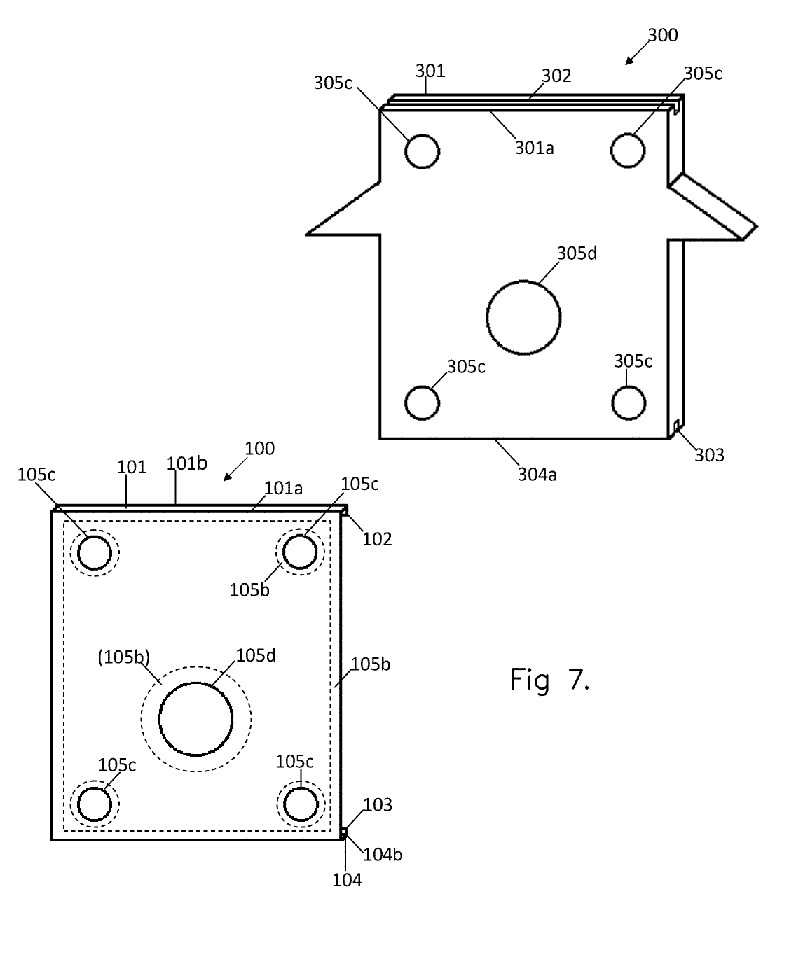

It should be understood that in any of the embodiments shown or described herein, a single upper tab 101 may extend across the entire width 106b of the filtering body 105, and/or a single lower tab 104 may extend across the entire width 106b of the filtering body 105, as suggested by what is depicted in exemplary non-limiting FIG. 7. It should also be understood that in any of the embodiments shown or described herein, a plurality of upper tabs 101 may be laterally spaced apart from each other along the upper corner 101a of the filter media 100 and may be spread out (e.g., evenly or non-evenly) across the width 106b of the filtering body 105, wherein a lateral space may be provided between each upper tab 101, as suggested by exemplary non-limiting FIG. 8. It should further be understood that in any of the embodiments shown or described herein, a plurality of lower tabs 104 may be laterally spaced apart from each other along the lower corner 104a of the filter media 100 and may be spread out (e.g., evenly or non-evenly) across the width 106b of the filtering body 105, wherein a lateral space may be provided between each lower tab 104.

Each of the one or more tabs 101, 104, whether provided to upper or lower portions of filter media 100 may comprise a plurality of locking elements 102, 104. In instances where a plurality of tabs and/or a plurality of locking elements are provided to a portion of filter media 100, a respective number of complimentary and independent locking elements may be provided to reciprocal mating portions of a filter plate 300, without limitation. In some embodiments, a plurality of tabs and/or a plurality of locking elements provided to a portion of filter media 100 may share the same filter plate locking element 102, 103, without limitation. In some embodiments, an upper locking element 102 from a first filter media 100 and an upper locking element 102 from a second filter media 100 may share the same upper locking element 302 of a filter plate 300, without limitation. In some embodiments, a lower locking element 103 from a first filter media 100 and a lower locking element 103 from a second filter media 100 may share the same lower locking element 303 of a filter plate 300, without limitation.

Filter media 100 is preferably designed to filter better than conventional scrim-supported needle felt filter media, that is, by providing a higher flowrate, a lower cycle time, and/or a longer life alternative, whilst maintaining adequate sealing capabilities and simple ease of use. Filter media 100 may allow filtration operations to minimize wash cycle times and/or wash fluid consumption, for example, by reducing the number of filtration cycles between wash cycles, without limitation. Moreover, depending on the thickness 107, height 106a, width 106b, material, and/or porosity of the filter media 100, embodiments of the invention may demonstrate improved stiffness, or lower stretch, which may help reduce deformation of the filter media 100 around pips and other raised or recessed profiles of a filter plate 300, without limitation. Embodiments of the invention may exhibit lower friction, and/or better wear characteristics, without limitation. The proposed filter media 100 may further exhibit improved hydrodynamic properties, thereby enhancing filtration.

### Example 1

According to one proof of concept embodiment, a filter media prototype may be constructed using sintered porous material selected from a micro-porous sheet of non-compactable crystalline high-density polyethylene HDPE POREX® brand Style EPN-01523). The micro-porous may be provided in any width, for example, approximately 28.75 inches. The micro-porous sheet may have an average pore size between approximately 10 and 20 micrometers and is preferably suitable for continuous service use at temperatures up to 180° F. (82° C.) and intermittent service use at 240° F. (116° C.)—when not stressed. The micro-porous sheet is intended to form a strong, lightweight, and tough filter media which is resistant to concentrated acids, alkalis, and many organic solvents. The micro-porous sheet is also designed to demonstrate significant non-stick properties with resistance to pore occlusion by slurry particles as well as wear from slurry particles. Edge perimeter portions of the micro-porous sheet may be occluded with an elastomer, silicone, rubberized product, or petroleum- and/or asphalt-based crumb rubber product, which may be applied via masking and spraying techniques. Upper and lower edges of the microporous sheet may be bent using heat and a form, to produce respective dovetail and partial dovetail locking features that correspond to those provided to the top and bottom of a filter plate; or, upper and lower tabs comprising dovetail and partial dovetail locking features may be extruded and then ultrasonically welded to the microporous sheet. A conventional filter plate of any manufacturer may be machined (e.g., via a flared rotary cutting tool) along its upper end surface and lower end surface and across its width,

In some preferred embodiments, the porous material 105a comprises at least one polymer. The at least one polymer may comprise at least one of: polyethylene, polypropylene, polyester, polycarbonate, polyvinylidene fluoride, polytetrafluoroethylene, polyvinylidene fluoride, ethyl vinyl acetate, polycarbonate, polycarbonate alloy, Nylon 6, thermoplastic polyurethane (TPU), polyethersulfone (PES), and polyethylene-polypropylene copolymer without limitation. For example, the at least one polymer of the porous material 105a may comprise high-density polyethylene (HDPE) or ultra-high molecular weight polyethylene (UHMWPE). The porous material 105a may be formed from particles of a first polymer and particles of a second polymer. The first polymer may be selected from the group consisting of: polyethylene, polypropylene, polyester, polycarbonate, polyvinylidene fluoride, polytetrafluoroethylene, polyethersulfone, polystyrene, polyether imide, polyetheretherketone, polysulfone, and a combination thereof. The second polymer may comprise a thermoplastic elastomer selected from the group consisting of: thermoplastic polyurethane, polyisobutylene, polybutene, polyethylene-propylene copolymer, polyethylene-butene copolymer, polyethylene-octene copolymer, polyethylene-hexene copolymer, chlorinated polyethylene, chloro-sulfonated polyethylene, styrene-ethylene-butadiene-styrene, multiblock copolymers having a polyurethane and either a polyester or polyether, 1,3-dienes, and a combination thereof. The porous material 105a may comprise a reticulated structure having a mean porosity between approximately 10% and 90%, for example, between approximately 20% and 80%, without limitation. In some preferred embodiments, porous material 105a may comprise a rigidity according to ASTM D747 of less than about 15 pounds, without limitation. A thickness 107 of the porous material 105a may be between approximately 0.5 and 25 mils thick, without limitation.

The porous material 105a may, in some preferred embodiments, be comprised of a plurality of particles 105a′ which have been sintered together. As shown in FIG. 6, polymeric particles 105a′ which have been sintered together to form the porous material 105a may form a series of voids or pores 105a″ between fenestrations 105a″′—thereby providing the porous material 105a with some amount of porosity and flexibility. The sintered particles 105a′ may comprise any number of polymeric materials which demonstrate one or more advantageous chemical and/or mechanical properties (e.g., such as resistance to wear, resistance to sticking, ability to easily release cake and/or slurry particles, resistance to solvents, increased flexibility, low friction coefficients, etc.). For example, the sintered particles 105a′ may, in some instances, comprise a combination of one or more elastomers and one or more hard plastics (e.g., at least one hard plastic particle and a plurality of different elastomeric particles which are sintered together; or, a plurality of different types of hard plastic particles and at least one type of elastomeric particle which are sintered together).

In certain embodiments, elastomers may make up between about 10 and 90%/wt of the porous material 105a. For example, approximately 20-80%/wt, 30-70%/wt, or 40-60%/wt of the porous material 105a may comprise elastomeric particles. In some non-limiting embodiments, approximately 50%/wt of the porous material 105a may comprise elastomeric particles. Particles 105a′ which are sintered to form the porous material 105a may be uniform (e.g., pellets, beads, or grains) or randomized in shape, without limitation. Particles 105a′ may be symmetrical or asymmetrical in shape, without limitation. Moreover, a size distribution of particles which are sintered may be uniform or randomized throughout portions of the porous material 105a, without limitation. In instances where a particle size distribution increases or decreases along a height 106a, width 106b or thickness 107 of the porous material 105a, a “functionally-graded” filtering body 105 may be provided having gradient porosity functionality (e.g., a reduced porosity in area towards the first face 109 of the filtering body 105, and an increased porosity in areas of the second face 110 of the filtering body 105, or vice versa), without limitation.

Particles 105a′ which are sintered to form the porous material 105a may each comprise a single homogeneous material, multiple types of materials, or one or more composite materials. For instance, a sintered particle 105a′ within the porous material 105a may comprise one or more monomers, polymers, plastics, elastomers and/or combinations thereof in a predetermined ratio. The filtering body 105 may take any desired shape or form, such as sheet or a film, or it may be crafted from a block of sintered porous material 105a which has been “sliced” into one or more thin sheets or films having a thickness 107 suitable for a filtering body 105. Filtering body 105 may also be fabricated to closely match or complement certain geometries of a filter plate 300, for example, to closely follow boss lines, edge lines, pips, recesses, protrusions, feed eye holes, etc., where they might be present on the filter plate 300, without limitation. This may be done through rapid prototyping techniques, 3D printing techniques, or customized tray molds which may receive un-sintered particles prior to sintering and which may be exposed to high temperatures.

It is envisaged that porous material 105a may be fabricated thinly, so as to exhibit improved flexibility. It is further envisaged that in some embodiments, the porous material 105a may be laminated to or otherwise joined to a nonwoven fibrous material (e.g., needled felt) and/or a woven material (e.g., cloth via one or more adhesive webs (not shown) to provide functionally-graded or composite filtering characteristics, without limitation. In some embodiments, the porous material 105a may be formed by fusing multiple layers of sintered porous material 105a together, without limitation.

Plastics, where used herein, may include flexible or soft plastics and rigid or hard plastics, without limitation, and may include polyolefins, polyamides, polyesters, rigid polyurethanes, polyacrylonitriles, polycarbonates, polyvinylchloride, polymethylmethacrylate, polyvinylidene fluoride, polytetrafluoroethylene, polyethersulfones, polystyrenes, polyether imides, polyetheretherketones, polysulfones, and/or combinations/copolymers thereof, without limitation. In some preferred embodiments, a polyolefin plastic may be selected as a material used in the porous material 105a. The polyolefin may comprise polyethylene, polypropylene, and/or copolymers thereof. In some embodiments, polyethylene may be utilized, which may comprise high density polyethylene (HOPE) having a density ranging from about 0.92 g/cm³ to about 0.97 g/cm³ or a degree of crystallinity (% from density) ranging from about 50 to about 90, without limitation. In some embodiments, polyethylene utilized in the porous material 105a may comprise ultrahigh molecular weight polyethylene (UHMWPE) having molecular weights greater than 1,000,000, without limitation.

In addition to at least one plastic, some of the polymeric materials of the sintered particles 105a′ provided within the porous material 105a may comprise at least one xo elastomer such as a thermoplastic elastomer (TPE) like polyurethane or thermoplastic polyurethane (TPU), without limitation. Thermoplastic polyurethanes may include, without limitation, multi-block copolymers comprising polyester or polyether, and polyurethane. In some embodiments, elastomers used to form the porous material 105a may comprise, without limitation, polyisobutylene, polybutenes, butyl rubber, or a combination thereof. In some embodiments, elastomers used to form the porous material 105a may comprise copolymers of ethylene and other polymers such as polyethylene-propylene copolymer (EPM), ethylene-butene copolymer, polyethylene-octene copolymer, and polyethylene-hexene copolymer, without limitation. In further embodiments, elastomers may comprise chlorinated polyethylene or chloro-sulfonated polyethylene, without limitation. In some embodiments, elastomers suitable for use in the porous material 105a of the filtering body 105 may comprise 1,3-dienes and derivatives thereof, without limitation. The 1,3-dienes may, for example, include styrene-1,3-butadiene (SBR), styrene-1,3-butadiene terpolymer with an unsaturated carboxylic acid (carboxylated SBR), acrylonitrile-1,3-butadiene (NBR or nitrile rubber), isobutylene-isoprene, cis-1,4-polyisoprene, 1,4-poly(1,3-butadiene), polychloroprene, block copolymers of isoprene or 1,3-butadiene with styrene, such as styrene-ethylene-butadiene-styrene (SEBS), or a combination thereof, without limitation. In some embodiments, elastomers may comprise polyalkene oxide polymers, acrylics, or polysiloxanes (silicones), or a combination thereof. Examples of commercially-available elastomers suitable for use in the porous material 105a may comprise FORPRENE®, LAPRENE®, SKYPEL®, SKYTHANE®, SYNPRENE®, RIMFLEX®, Elexar, FLEXALLOY®, TEKRON®, DEXFLEX®, Typlax, Uceflex, ENGAGE®, HERCUPRENE®, Novalene, Kraton, Multi-Flex, EVOPRENE®, HYTREL®, NORDEL®, VITON®, Vector, SILASTIC®, Santoprene, Elasmax, Affinity, ATTANE®, and SARLINK® brand products, without limitation.

Porosity in the porous material 105a may range from about 10% to about 90%, without limitation. For example, in some embodiments, the porous material 105a may comprise at least one hard plastic and at least one elastomer and may have a porosity ranging from about 20% to about 80% (e.g., between about 30% and about 70%, without limitation). In some embodiments, the porous material 1054 may comprise at least one hard plastic and at least one elastomer and may have a porosity, ranging between approximately 40% and 60% (e.g., about 50% open space, without limitation). In some preferred embodiments, the porous material 105a may comprise micro porosities or regions of randomized or varying porosity throughout the filtering body 105, without limitation. In some instances, the porous material 105a may comprise an average pore size ranging from about 1 μm to about 200 μm, without limitation. For example, in some non-limiting embodiments, pore size may be between about 2 μm and 150 μm, between about 5 μm and 100 μm, or between about 10 μm and 50 μm, without limitation. In some embodiments, porous material 105a may comprise an average pore size of less than about 1 μm (e.g., between about 5.1-1 μm), without limitation. In further embodiments, pore sizes may exceed 200 μm, without limitation. In one particular non-limiting embodiment, porous material 105a comprising at least one hard plastic and at least one elastomer may have an average pore size ranging from about 200 μm to about 500 μm or from about 500 μm to about 1 mm, without limitation.

The porous material 105a may have a density between approximately 0.05 g/cm³ and 0.5 g/cm³, and more particularly between approximately 0.1 g/cm³ and 0.25 g/cm³, without limitation. In some instances, density of the porous material 105a may fall between 0.1 and 0.4 g/cm³ (e.g., about 0.25 g/cm³), without limitation. In further embodiments, a porous material 105a may comprise at least one hard plastic and at least one elastomer and may exhibit a density greater than about 0.05 g/cm³ or a density greater than about 0.1 g/cm³. In yet even further embodiments, the sintered porous material 30 may have a density less than about 0.5 g/cm³, or less than about 0.25 g/cm³, without limitation. Porous material 105a described herein may further comprise a rigidity according to ASTM D747 (i.e., “Standard Test Method for Apparent Bending Modulus of Plastics by Means of a Cantilever Beam”) of less than about 15 pounds, for example, less than about 10 pounds, without limitation. In some embodiments, a rigidity of the porous material 105a may be less than about 5 pounds, for example, less than about 1 pound, without limitation. Tensile strength of the porous material 105a may range from about 10 to about 5,000 ps as measured according to ASTM D638, without limitation, For example, in some embodiments, the tensile strength of the porous material 105a may fall within the range of about 50 to 3000 psi or between 100 and 1,000 psi as measured according to ASTM 0638, without limitation.

In some embodiments, porous material 105a comprising at least one hard plastic particle sintered with at least one elastomeric particle may have an elongation of 10% to 500%, without limitation. In some embodiments, the porous material 105a may be provided in thicknesses less than ¼″, and above 1/16″, for example around ⅛″ or around 0.07 to 0.09 inches, without limitation. In some embodiments, the porous material 105a may be provided in thicknesses less than ⅛″, but above 1/32″, for example around ⅙″; or, around 0.05 to 0.07 inches, without limitation, in some embodiments, the porous material 105a may be provided in thicknesses between about 1 mm and about 5 mm, for example, about 2 mm, without limitation.

In use, filtration solids are stopped, held, or hindered by the sintered particles 105a′ and fenestrations 105a″′ within the porous material 105a. Voids or pores 105a″ within the porous material 105a are configured to prevent migration of filtration solids from penetrating through the filtering body 105, as well as prevent, slow, or hinder migration of filtration solids through the filtering body 105. The rigidity and toughness of the porous material 105a is preferably configured to help prevent solids (which may get trapped in pores 105″) from experiencing micro-motion and wear commonly seen with conventional woven cloth filter media. Occlusion material may be used to fill pores 105a″ and thus prevent lateral migration of solids within the filtering body 105.

Preferred embodiments of porous material 105a may comprise ultra-high molecular weight polyethylene (UHMWPE). Porous material 105a disclosed herein may, however, comprise one or more types of polyethylene (PE), including low density-types (LOPE), high density types (HDPE), ultra-high molecular weight types (UHMWPE), or a combination thereof, without limitation.

Although the invention has been described in terms of particular embodiments and applications, one of ordinary skill in the art, in light of these teachings, can generate additional embodiments and modifications. It should be further noted that the particular geometries of components shown in the drawings are merely schematic representations that are not to scale, and they may vary from what is shown. It is anticipated by the inventor that any number of variations and/or combinations of features or elements described herein may be practiced without departing from the scope of the invention. It should further be understood that the term “at least one”, where used herein, including the description and the claims, shall mean “one or more”, “one”, “two”, “multiple”, or “a plurality”, interchangeably, without limitation. Accordingly, it is to be understood that the drawings and descriptions herein are proffered by way of example to facilitate comprehension of the invention and should not be construed to limit the scope thereof.

### REFERENCE NUMERAL IDENTIFIERS

100 filter media for dewatering slurry in an industrial filter press

101 at least one upper tab extending from filtering body

101a upper corner of filter media

101b first upper tab edge

101c second upper tab edge

102 at least one upper locking element (e.g., dovetail, barb)

102a first upper locking element face

102b first upper locking element edge

102c second upper locking element face

102d second upper locking element edge

102e third upper locking element face

103 at least one lower locking element (e.g., dovetail, barb)

103a first lower locking element face

103b first lower locking element edge

104 at least one lower tab extending from filtering body

104a lower corner of filter media

104b first lower tab edge

105 filtering body (e.g., microporous sheet of sintered porous material)

105a porous material (non-occluded pores)

105a′ sintered particle

105a″ pore

105a′″ fenestration

105b porous material (occluded pores, e.g., occluded with an elastomer)

(105b) porous material (optionally occluded pores)

105c one or more corner openings (e.g., filtrate hole(s), air blow hole(s))

105d one or more central openings (e.g., slurry feed eye hole(s))

106a filtering body height/filter plate height

106b filtering body width/filter plate width

107 filtering body thickness

108 tab depth

109 first face of filtering body

110 second face of filtering body

300 filter plate for an industrial filter press

301 upper end surface of filter plate

301a upper corner of filter plate

301b first upper end surface edge

301c second upper end surface edge

302 at least one upper locking element (e.g., dovetail)

302a first upper locking element face

302b first upper locking element edge

302c second upper locking element face

302d second upper locking element edge

302e third upper locking element face

303 at least one lower locking element (e.g., dovetail)

303a first lower locking element face

303b first lower locking element edge

303c second lower locking element face

303d second lower locking element edge

303e third lower locking element face

304 lower end surface of filter plate

304a lower corner of filter plate

304b first lower end surface edge

304c second lower end surface edge

305c one or more corner openings (e.g., filtrate hole(s), air blow hole(s))

309 first face of filter plate

310 second face of filter plate

1. Filter media (100) for dewatering slurry in an industrial filter press, the filter media (100) comprising:
a filtering body (105) comprising non-occluded porous material (105a) and occluded porous material (105b), the filtering body (105) further comprising at least one opening (105c, 105d) extending entirely through the occluded porous material portion (105b) of the filtering body (105);
at least one upper tab (101) comprising at least one upper locking element (102); the at least one upper tab (101) extending from the filtering body (105) to form an upper edge (101a) between the at least one upper tab (101) and the filtering body (105); and,
at least one lower tab (104) comprising at least one lower locking element (103); the at least one lower tab (104) extending from the filtering body (105) to form a lower edge (104a) between the at least one lower tab (104) and the filtering body (105);
wherein the occluded porous material (105b) comprises a portion of the non-occluded porous material (105a) that has been treated with a polymeric material configured to discourage lateral migration of solids within the filtering body (105) and/or configured to improve sealing around the filtering body (105);
wherein the filtering body (105) is configured to cover a first and/or second face (309, 310) of a filter plate (300), the filter plate (300) comprising at least one upper locking element (302) provided to an upper end surface (301) of the filter plate (300), the filter plate (300) further comprising at least one lower locking element (303) provided to a lower end surface (304) of the filter plate (300);
wherein the at least one upper tab (101) of the filter media (100) is configured to communicate with the at least one upper locking element (302) at the upper end surface (301) of the filter plate (300) so as to prevent removal of the filtering body from the filter plate (300) during use; and
wherein the at least one lower tab (104) of the filter media (100) is configured to communicate with the at least one lower locking element (303) at the lower end surface (304) of the filter plate (300) so as to prevent removal of the filtering body (105) from the filter plate (300) during use.

2. The filter media (100) of claim 1, wherein the non-occluded porous material (105a) comprises sintered porous material comprised of a plurality of polymeric sintered particles (105a′), pores (105a″) between the sintered particles (105a′), and a number of fenestrations (105a) extending between the sintered particles (105a); wherein at least some of the sintered particles (105a′) are comprised of a polymer selected from the group consisting of: polyethylene, high-density polyethylene (HDPE), ultra-high molecular weight polyethylene (UHMWPE), polypropylene, polyester, polycarbonate, polyvinylidene fluoride, polytetrafluoroethylene, polyvinylidene fluoride, ethyl vinyl acetate, polycarbonate, polycarbonate alloy, nylon 6, thermoplastic polyurethane (TPU), polyethersulfone (PES), and polyethylene-polypropylene copolymer.

3. The filter media (100) of claim 2, wherein at least some of the sintered particles (105a′) are comprised of a thermoplastic elastomer selected from the group consisting of: thermoplastic polyurethanes, polyisobutylene, polybutenes, polyethylene-propylene copolymer, polyethylene-butene copolymer, polyethylene-octene copolymer, polyethylene-hexene copolymer, chlorinated polyethylene, chloro-sulfonated polyethylene, styrene-ethylene-butadiene-styrene, multiblock copolymers having a polyurethane and either a polyester or polyether, and 1,3-dienes.

4. The filter media (100) of claim 3, wherein the non-occluded porous material (105a) comprises a reticulated structure having a mean porosity between 20% and 80%.

5. The filter media (100) of claim 4, wherein the non-occluded porous material (105a) comprises a rigidity, according to ASTM D747, of less than 15 pounds.

6. The filter media (100) of claim 1, wherein the at least one upper locking element (102) of the at least one upper tab (101) comprises a first upper tab edge (101b), a first upper locking element face (102a), and a first upper locking element edge (102b); the first upper tab edge (101b) being configured to communicate with a first upper end surface edge (301b) provided to an upper end surface (301) of a filter plate (300); the first upper locking element face (102a) being configured to communicate with a first upper locking element face (302a) adjacent an upper end surface (301) of a filter plate (300) and forming a portion of the at least one upper locking element (302); and the first upper locking element edge (102b) being configured to communicate with a first upper locking element edge (302b) adjacent an upper end surface (301) of a filter plate (300) and forming a portion of the at least one upper locking element (302); wherein the first upper locking element face (102a) forms an undercut with an upper end surface (301) of a filter plate (300).

7. The filter media (100) of claim 6, wherein the at least one lower locking element (103) of the at least one lower tab (104) comprises a first lower tab edge (104b), a first lower locking element face (103a), and a first lower locking element edge (103b); the first lower tab edge (104b) being configured to communicate with a first lower end surface edge (304b) provided to a lower end surface (304) of a filter plate (300); the first lower locking element face (103a) being configured to communicate with a first lower locking element face (303a) adjacent a lower end surface (304) of a filter plate (300) and forming a portion of the at least one lower locking element (303); and the first lower locking element edge (103b) being configured to communicate with a first lower locking element edge (303b) adjacent a lower end surface (301) of a filter plate (300) and forming a portion of the at least one lower locking element (303); wherein the first lower locking element face (303a) forms an undercut with a lower end surface (304) of a filter plate (300).

8. The filter media (100) of claim 7, wherein the at least one upper locking element (102) of the at least one upper tab (101) further comprises a second upper locking element face (102c) extending from the first upper locking element edge (102b) to a second upper locking element edge (102d), and wherein the at least one upper locking element (102) of the at least one upper tab (101) further comprises a third upper locking element face (102e) extending from the second upper locking element edge (102d) to a second upper tab edge (101c); the second upper tab edge (101c) being configured to communicate with a second upper end surface edge (301c) provided to the upper end surface (301) of a filter plate (300);
the second upper locking element face (102c) being configured to communicate with a second upper locking element face (302c) adjacent the upper end surface (301) of a filter plate (300) and forming a portion of the at least one upper locking element (302); and the second upper locking element edge (102d) being configured to communicate with a second upper locking element edge (302d) adjacent the upper end surface (301) of a filter plate (300) and forming a portion of the at least one upper locking element (302); wherein the third upper locking element face (102e) forms an undercut with the upper end surface (301) of a filter plate (300).

9. A method of manufacturing the filter media (100) described in any one of the preceding claims, the method comprising:
sintering polymeric particles (105a′) together to form a filtering body (105) comprising non-occluded porous material (105a), the non-occluded porous material (105a) being defined by a number of pores (105a″) and fenestrations (105e);
forming or providing at least one upper tab (101) which extends from the filtering body (105) for a tab depth (108);
forming or providing at least one upper locking element (102) on the at least one upper tab (101);
forming or providing at least one lower tab (104) which extends from the filtering body (105) for a tab depth (108);
forming or providing at least one lower locking element (103) on the at least one lower tab (104);
occluding a portion of the non-occluded porous material (105a) of the filtering body (105) with a polymeric material to create a region of occluded porous material (105b); and
forming or providing at least one opening (105c, 105d) through the filtering body (105).

10. The method of claim 9, wherein the step of forming or providing at least one opening (105c, 105d) through the filtering body (105) comprises forming or providing a corner opening (105c) through the occluded porous material (105b).

11. The method of claim 10, wherein the step of forming or providing at least one opening (105c, 105d) through the filtering body (105) further comprises forming or providing a central opening (105d) through occluded porous material (105b) or non-occluded porous material (105a) of the filtering body (105).

12. The method of claim 9 further comprising the step of forming or providing at least one upper locking element (302) on an upper end surface (301) of a filter plate (300), the at least one at least one upper locking element (302) comprising a first upper end surface edge (301b), a first upper locking element face (302a), a first upper locking element edge (302b), a second upper locking element face (302c), a second upper locking element edge (302d), a third upper locking element face (302e), and a second upper end surface edge (301c); wherein the first upper locking element face (302a) forms an undercut with the upper end surface (301);
and wherein the second upper locking element face (302e) forms an undercut with the upper end surface (301).

13. The method of claim 12, wherein the step of forming or providing at least one upper locking element (302) on an upper end surface (301) of a filter plate (300) is performed using a flared rotary cutting tool, the flared rotary cutting tool being moved along a width (106b) of the filter plate (300) and into the filter plate (300) to form or provide at least one upper locking element (302) on the upper end surface (301) as a at least one undercut recess.

14. The method of claim 13, wherein the flared rotary cutting tool is a bit capable of use within a drill, router, mill, or rotary cutting tool.

15. A filter plate (300) for an industrial filter press comprising the filter media (100) described in any of claims 1-11, the filter plate (300) comprising:
an upper end surface (301) comprising at least one upper locking element (302) defined by a first upper end surface edge (301b), a first upper locking element face (302a), a first upper locking element edge (302b), and a second upper locking element face (302c);
a lower end surface (304) comprising at least one lower locking element (303) defined by a first lower end surface edge (304b), a first lower locking element face (303a), a first lower locking element edge (303b), and a second lower locking element face (303c);
a first face (309);
a second face (310);
a first upper corner (301a) adjacent the first face (309), a second upper corner (301a) adjacent the second face (310);
a first lower corner (304a) adjacent the first face (309), a second lower corner (304a) adjacent the second face (310);
wherein the at least one upper locking element (302) of the filter plate (300) is configured to receive the at least one upper locking element (102) of the filter media (100);
wherein the at least one lower locking element (303) of the filter plate (300) is configured to receive the at least one lower locking element (103) of the filter media (100); and
wherein the filter plate (300) further comprises at least one opening (305c, 305d) which aligns with the at least one opening (105c, 105d) extending entirely through the occluded porous material portion (105b) of the filtering body (105) of the filter media (100).

16. The filter plate (300) and filter media (100) of claim 15, wherein the filter plate (300) further comprises a second upper locking element edge (302d), a third upper locking element face (302e), and a first upper end surface edge (304c).

17. The filter plate (300) and filter media (100) of claim 16, wherein the filter plate (300) further comprises a second lower locking element edge (303d), a third lower locking element face (303e), and a second lower end surface edge (304c).

18. A filter media (100), a filter plate (300), or a combination thereof, as substantially described in the description and depicted in the drawings.

19. A method of making a filter media (100), a filter plate (300), or a combination thereof, as substantially described in the description and depicted in the drawings.
